(19) United States
(12) Patent Application Publication
(10) Pub. No.: US 2014/0148744 A1
(43) Pub. Date: May 29, 2014

(54) ROLLER DEVICE FOR LYMPHATIC DRAINAGE TREATMENTS

(71) Applicant: Rinaldo Caldirola, Merate (IT)

(72) Inventor: Rinaldo Caldirola, Merate (IT)

(73) Assignee: CIZETA MEDICALI S.p.A., Cuggiono, Milano (IT)

(21) Appl. No.: 14/232,165

(22) PCT Filed: Jul. 13, 2012
(86) PCT No.: PCT/IB2012/053594

§ 371 Date: Jan. 10, 2014

(30) Foreign Application Priority Data
Jul. 14, 2011 (IT) TO2011A000623

(51) Int. Cl. A61H 15/00

(52) U.S. Cl. CPC A61H 15/0092
USPC 601/119

(57) ABSTRACT

A roller device for lymphatic drainage treatments includes a handle (2), a rod (4) having one end connected to the handle (2) and a roller (6) rotatably mounted at the other end of the rod. The rod (4) is retractably mounted with respect to the handle, being movable between an extended position and a retracted position against the action of elastic (14) for maintaining the rod in the extended position, in such a manner that a pressure increase exerted on the roller causes the retraction of the rod. The device preferably includes a signaler which supplies a signal indicative of the level of pressure exerted on the roller, and enables its display.

The present invention relates to a roller device intended to be used in particular for lymphatic drainage treatments in order to treat localized subcutaneous oedema.

Conventional lymphatic drainage treatment acts on the lymphatic system in order to promote the absorption of the oedema and consists in a mechanical action to compress the surface of the body to be treated (for instance lower and upper limbs, chest and face) obtained by running a suitably dimensioned roller over the body surface affected by the oedema.

The time sequence of the zones to be treated and the working pressure are selected as a function of the spatial location of the oedema and its extent.

The object of the present invention is to provide a roller device which makes it possible to carry out a controlled and reproducible operation, allowing the operator to decide upon and regulate the most important treatment parameters, in particular the minimum, maximum and average pressure exerted by the operator on the individual treatment zone, thereby making it possible to maximize the effects of the treatment.

In a particular embodiment, the object of the invention is to provide a device which enables the operator also to determine the treatment time for each individual treatment zone and/or the treatment sequence of the individual zones.

A further object of the invention is to provide a device which achieves the above-mentioned objects by means of a structure which is relatively simple and economic from a constructional point of view.

In view of these objects, the invention relates to a roller device having the features set out in the appended claims which supplement and are an integral part of the present specification.

Other advantages and features of the device of the invention will become clear from the following detailed description, provided purely by way of non-limiting example, of embodiments of the device, given with reference to the appended drawings, in which:

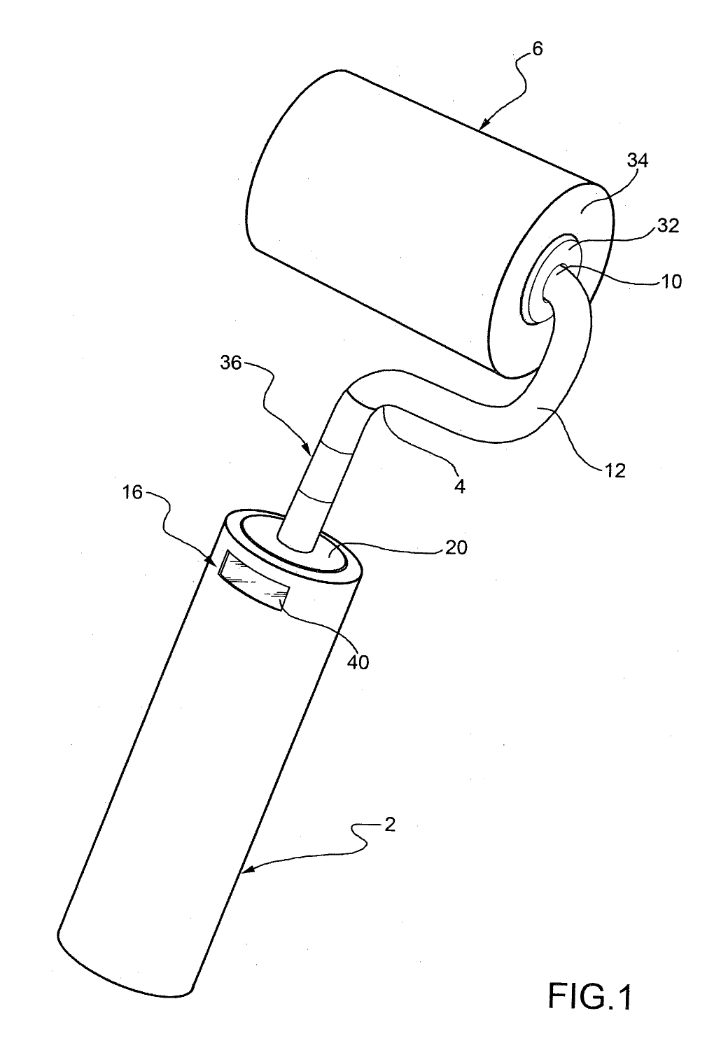

FIG. 1 is a perspective view of the device;

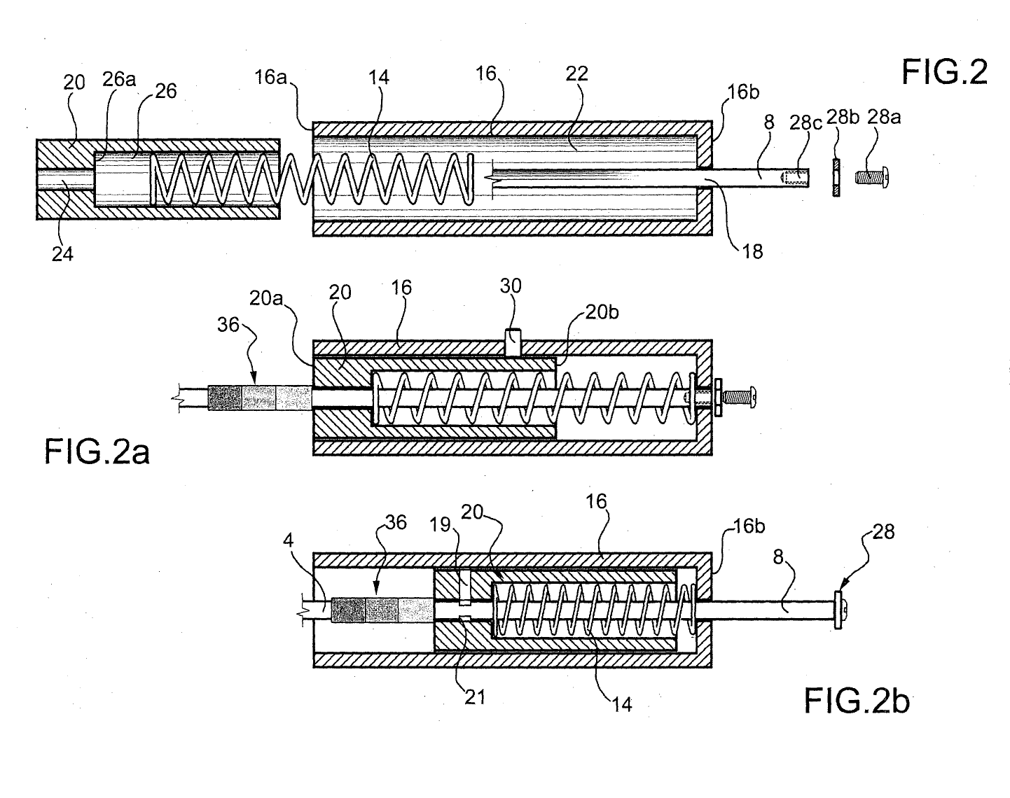

FIG. 2 is a view of part of the device in exploded cross-section;

FIGS. 2a and 2b are cross-sectional views showing part of the device in two operating positions: in an extended position in FIG. 2a and in a retracted position in FIG. 2b;

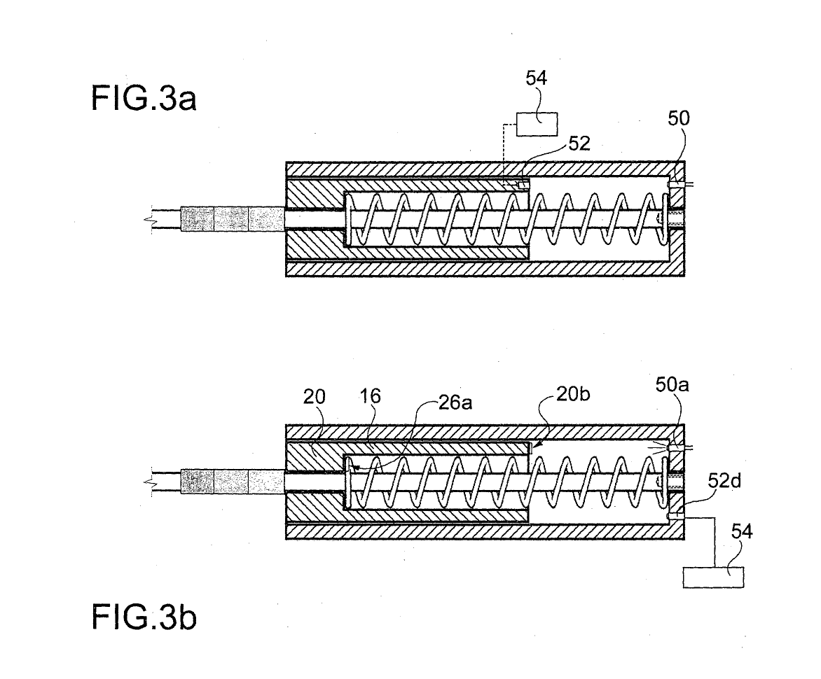

FIGS. 3a and 3b are cross-sectional views, corresponding to FIG. 2a, showing the handle portion of the device with relative signal means; and

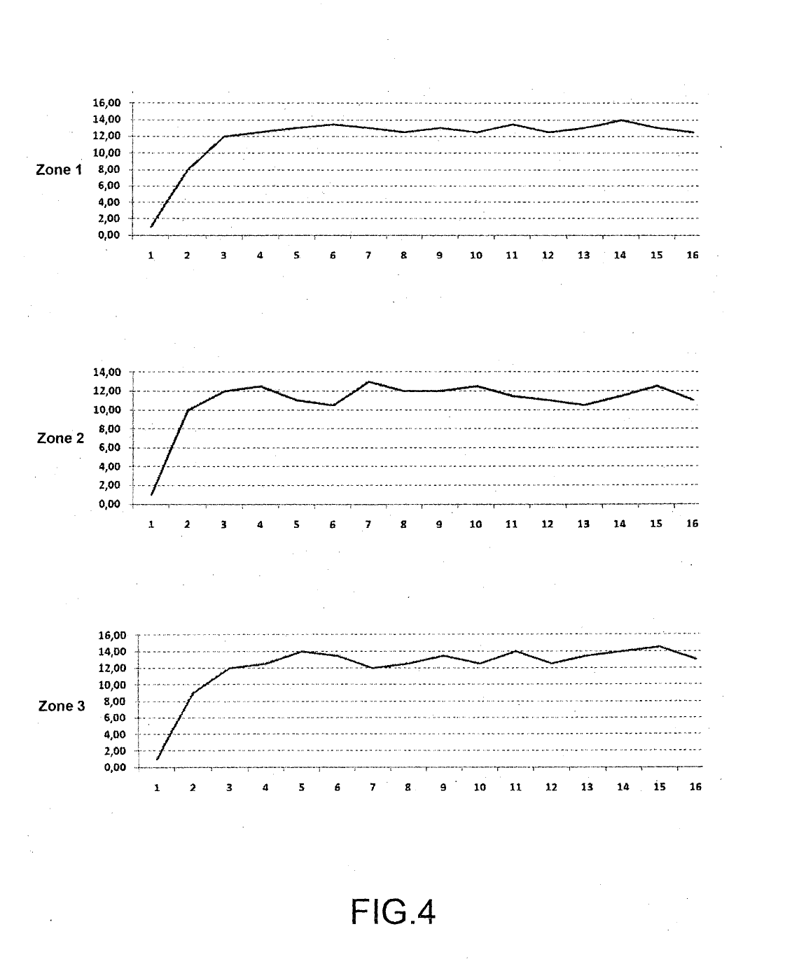

FIG. 4 shows a display screen including diagrams of the force applied (abscissa) as a function of the treatment duration time (ordinate) for the plurality of treatment zones.

With reference to the drawings, the device of the invention comprises a handle, shown overall by 2, a rod 4 having one end connected to the handle 2, and a roller 6 rotatably mounted at the other end of the rod 4.

The rod 4 has an end section 8, an intermediate bent section 12 and a rectilinear end section 10 which defines the axis of articulation of the roller 6.

The rod 4 is connected to the handle 2 in a retractable manner and may move with respect to the handle 2 between an extended position and a retracted position against the action of resilient means 14, associated with the handle, for maintaining the rod in the stable extended position; in this way, when a pressure increase is exerted on the roller 6, the rod 4 is caused to retract against the action of the resilient means 14.

In the embodiment shown, the handle 2 comprises a tubular cylindrical body 16 (wherein the term cylindrical, as used in this specification, should not be understood as limited to a circular cylinder) which forms the handling member for the operator, having an open end 16a and an end 16b closed by an end wall having a through hole 18 in which the end 8 of the rod 4 may slide.

A second tubular cylindrical body, for which the term cursor is hereafter used, is shown by 20. The cursor 20 has a cross-sectional dimension such that it may be mounted to slide, in the longitudinal direction, in the cavity 22 of the first tubular body 16 and has a through hole 24 in which the rod 4 may be inserted and locked such that the rod 4 is rigid with the cursor 20. The rod is locked with respect to the cursor for instance by means of a threaded pin 19 inserted in a through hole of the tubular wall of the cursor 20 designed to engage with a throat 21 of the rod 4 (FIG. 2b).

The hole 24 of the cursor 20 has a broader section 26 designed to house the resilient means 14 formed in the embodiment by a coil spring. When the cursor 20 is inserted in the first tubular body, in a sliding manner, the spring 14 which surrounds the rod 4 is housed in the cavity formed between the end wall 16b and the annular wall 26a of the broader section 26.

As mentioned above, in the device of the invention, the cursor 20, inserted in the handle 2, and the rod 4 rigid therewith, may move between a retracted position, shown in FIG. 2a, in which the end 16a of the tubular body 16 or handle and the end surface 20a of the cursor 20 are preferably substantially flush, and a retracted position in which the cursor 20 is positioned within the cavity 22.

The movement of the cursor 20 and the rod 4 from the extended position to the retracted position is opposed by the resilient means 14. The cursor 20 is caused to retract by a pressure increase exerted on the roller 6 during treatment.

Thus, in the course of treatment, the pressure exerted by the roller 6 on the treatment surface is proportional to the resilient force generated by the compression of the resilient means 14. Stop means 28 which in the embodiment shown comprise a screw 28a, a washer 28b and a hole 28c for the screw 28a are provided at the end of the rod 4 in order to define an end-of-stroke position of the rod 4 and ensure that the rod cannot become disengaged from the tubular body 16 forming the handle.

In an embodiment, second stop means may be provided so that the cursor 20 and the rod 4 associated therewith may be locked in a predetermined relative position; these stop means are formed for instance by a threaded pin 30 inserted in a hole of the tubular wall of the body 16 whose end may mesh with the outer surface of the cursor 20 in order to stop it from sliding.

The roller 6, mounted to rotate about the end 10 of the rod 4, about an axis which is substantially perpendicular to the axis of the handle 2 and the terminal end 8 of the rod 4, comprises a rigid tubular body 32 mounted to rotate about the end of the rod and a tubular covering body 34, which may be replaced, preferably having a resilient and spongy, but not necessarily absorbent, structure; it may for instance be a tubular body of neoprene or like flexible material.

According to a further feature of the invention, the device preferably comprises signal means intended to provide a signal indicative of the pressure level or of the compression force exerted on the roller, during treatment.

In an embodiment, the signal means include a graduated scale 36 associated with the rod 4. In the stable extended position of the rod 4 (shown in FIG. 2a), the graduated scale 36 is in a position external to the tubular cylindrical body 16 and extends along the rod from an end surface 20a of the cursor 20.

When, following a pressure increase, the cursor 20 and the rod 4 assume a position retracted within the cylindrical body 16, the graduated scale 36 is only partially visible to the operator; extending the visible region allows the operator to display a signal indicative of the pressure. For instance, the graduated scale 36 may be a scale formed by consecutive regions of different colour or, as an alternative, may be a numerical scale.

As an alternative, but less preferably, the graduated scale 36 could be associated with the terminal end 8 of the rod 4, enabling the operator to display the level of pressure exerted as a function of the longitudinal extension of the rod externally to the wall 16b.

In a further embodiment, the signal means comprise position sensor means disposed to generate an electrical signal indicative of the relative position of the cylindrical body 16 with respect to the cursor 20 or with respect to the rod 4 associated therewith and processing means 54 for said signal (for instance a microprocessor) disposed to transmit a signal representative of the pressure or force generated on the roller which is a function of the elongation/compression of the resilient means 14 and therefore of the relative position between the cylindrical body 16 and the cursor 20.

The signal representative of pressure may be displayed by an analogue or digital display, for instance a display 40 associated with the handle 2, or via a screen external to the roller device.

The position sensor means for instance comprise a transmitter 50 (for instance a light-emitting diode) disposed in the cylindrical body 16, for example, associated with its end wall 16b and a sensor (for instance a phototransistor) 52 associated with the annular end surface 20b of the cursor 20 (FIG. 2a) and intended to receive the radiation transmitted by the transmitter (FIG. 3a).

As an alternative, the position sensor means may comprise a transmitter (photodiode) 50a which, as mentioned above, is associated with the end wall 16b, and a phototransistor 52a, also associated with the end wall 16b, and the cursor 20 may be provided with reflective surfaces or means 51 a and/or 51b able to reflect the radiation transmitted from the photodiode 50a to the phototransistor 52a; these reflective surfaces or means may for instance be associated with the annular surface 20b of the cursor 20 or the annular surface 26a of the chamber 26 of the cursor 20.

In both cases, the signal transmitted by the phototransistor 52a is supplied to a microprocessor 54 for the processing of the signal and the transmission of a signal representative of the pressure to a display.

The microprocessor 54 may be integrated in the roller device (for instance in a part of the handle) or may be a microprocessor which is external or integrated in a personal computer. The microprocessor of the invention may be designed to generate an instantaneous display signal of the treatment parameters and/or to acquire and store certain treatment parameters which, at a subsequent data analysis stage, may make it possible objectively to monitor the accurate application of the treatment.

The microprocessor 54 may in particular be disposed to supply parameters representative of the following indications.

Indication of the Pressure Exerted

As mentioned above, the signal indicative of the pressure exerted is obtained by means of the optical position sensor means described above, which make it possible to determine the force applied to the roller 6 as a function of the elongation (or compression) of the resilient means 14; the microprocessor 54, via an appropriate transfer function, undertakes the linearization of the signal transmitted by the phototransistor 52, 52a which is proportional to the light intensity received and varies with the square of the path of the radiation between the transmitter 50, 50a and the phototransistor.

Working Time on the Individual Zone

Working time on the individual treatment zone is measured as the difference between a work start signal and a work end signal. By setting a threshold for the force exerted (as in the preceding point) it is possible to establish both the moment at which the operator starts work and the moment at which said work is complete. In particular:
the start of work is signalled when the threshold is exceeded, when the force exerted is always greater than the predetermined minimum threshold (for a certain continued time);
the end of work is signalled when the force exerted is lower (for a certain continued time) than the predetermined minimum threshold.

The threshold may be set at a value which is unequivocally lower than the minimum force required by the treatment method.

As mentioned above, the microprocessor 54 may be integrated in the handle, in which case the signals transmitted by the microprocessor 54 may be displayed on a display 40 borne by the handle 2 and may be external to the roller device, in which case it is a device integrated in or external to a personal computer.

In this second embodiment, the processing unit or personal computer may be disposed to operate according to an application able to display the information acquired on a screen.

By way of example, the processing unit may be disposed to provide the display of the type shown in FIG. 4, i.e. a diagram which for instance provides, for each zone of work, the extent of the force applied (on the abscissa) as a function of the duration time of the individual compression treatment (on the ordinate). The screen may provide a representation of a plurality of working zones.

By way of example, the extent of the force applied and the treatment duration time may be calculated as mean values of multiple passages of the roller device over the individual working zone, as provided for by the treatment.

As mentioned above, the microprocessor 54 may also be disposed to supply the values of the following parameters:
minimum, maximum and average pressure exerted by the operator on the individual treatment zone;
processing time for each zone;
treatment sequence of the individual areas.

The roller device of the invention is particularly intended for lymphatic drainage treatment methods; however, it will be appreciated that the device could also be used for localized cutaneous treatments which may not have strictly therapeutic aims, but cosmetic aims, for instance massage treatments.

Naturally, the principle of the invention remaining the same, the forms of embodiment and details of construction may be varied widely with respect to those described and illustrated, which have been given purely by way of example, without thereby departing from the scope of the invention.

1. A roller device for lymphatic drainage treatments comprising:
a handle;
a rod having one end connected to the handle, and
a roller rotatably mounted at the other end of the rod;
biasing means for maintaining the rod in the extended position;
wherein the rod is retractably mounted with respect to the handle, being movable between an extended position and a retracted position against action of the biasing means, in such a manner that a pressure increase exerted on the roller causes retraction of the rod, and
signalling means for displaying to the operator a signal indicative of the level of pressure exerted on the roller, during treatment.

2. A roller device according to claim 1, wherein the signalling means provide a signal indicative of the pressure level or of the compression force exerted on the roller, during treatment.

3. A roller device according to claim 1, comprising:
a cylindrical tubular body acting as the handle,
a cursor secured to the rod, mounted so as to be longitudinally slidable in the cylindrical tubular body,
resilient coil spring means, inserted in the cylindrical tubular body in a position interposed between the cursor and an end wall of the cylindrical tubular body, to oppose longitudinal sliding of the cursor from the extended position to the retracted position.

4. A roller device according to claim 3, wherein the rod is secured to the cursor, being inserted into a through hole of the cursor and has an end portion slidably inserted in the end wall of the cylindrical tubular body.

5. A roller device according to claim 4, wherein stop means are associated with said end portion of the rod, said stop means defining an end-of-stroke position of the rod relative to the cylindrical tubular body.

6. A roller device according to claim 1, wherein said signalling means include a graduated scale associated with the rod.

7. A roller device according to claim 6, wherein said graduated scale extends along a portion of the longitudinal extension of the rod, adjacent to the cursor.

8. A roller device according to claim 1, wherein the signalling means provide a signal indicative of pressure level or of compressive force exerted on the roller, said signalling means including position sensing means arranged for generating a signal indicative of the relative position of the cylindrical body with respect to the cursor.

9. A roller device according to claim 8, wherein said position sensing means include a radiation transmitter associated with the cylindrical tubular body and a sensor, associated with the cursor, said sensor being capable of emitting a signal representative of the path between transmitter and sensor.

10. A roller device according to claim 8, wherein said position sensing means include a radiation transmitter and a radiation sensor, both associated with the hollow tubular body and reflecting means associated with a surface of the cursor for reflecting the signal transmitted by the emitter towards the sensor.

11. A roller device according to claim 8, further comprising processing means of the signal emitted by said sensor in order to generate a signal representative of the pressure exerted on the roller and means for displaying said signal.

12. A roller device according to claim 11, wherein said processing means include a microprocessor associated with the handle or external to the handle.

13. A roller device according to claim 11, wherein said processing means are adapted to provide a display of parameters selected from one or more of the following:
minimum, maximum and average pressure exerted by the operator on the individual treatment zone;
processing time for each zone;
treatment sequence of individual areas.

14. A device according to claim 1 adapted for treatment of oedema.
